(19) United States
(12) Patent Application Publication
(10) Pub. No.: US 2025/0257833 A1
(43) Pub. Date: Aug. 14, 2025

(54) MULTI-COUPLING FOR MEDIA LINES

(71) Applicant: VOSS Automotive GmbH, Wipperfürth (DE)

(72) Inventors: Harald HAGEN, Wipperfürth (DE); Ihab HATOUM, Kürten (DE); Reiner MITTERER, Wipperfürth (DE)

(21) Appl. No.: 18/856,378

(22) PCT Filed: Apr. 6, 2023
(86) PCT No.: PCT/EP2023/059280

§ 371 Date: Oct. 11, 2024

(30) Foreign Application Priority Data
Apr. 13, 2022 (DE) 10 2022 109 117.1
Sep. 28, 2022 (DE) 10 2022 125 050.4

(51) Int. Cl. F16L 37/56

(52) U.S. Cl. CPC F16L 37/56

(57) ABSTRACT

A multiple coupling for media lines, with at least one first plate-shaped coupling carrier, at least one second plate-shaped coupling carrier and a plurality of plug-in coupling parts. The first coupling carrier has at least a first receptacle and a second receptacle. The second coupling carrier has at least one first receptacle and one second receptacle. The multiple coupling for media lines, which prevents incorrect assembly of plug-in coupling parts and in which the manufacturing effort is reduced, is realized in that the first receptacle and the second receptacle of at least the second coupling carrier each have at least one stop, and in that the stop of the first receptacle has a different extension along a longitudinal axis than the stop of the second receptacle in order to realize different insertion depths for different plug-in coupling parts.

### BACKGROUND

### 1. Field of the Invention

The invention relates to a multiple coupling for media lines, with at least one first plate-like coupling carrier, at least one second plate-like coupling carrier and a plurality of plug-in coupling parts. The first coupling carrier has at least a first receptacle and a second receptacle. The second coupling carrier also has at least one first receptacle and one second receptacle. The receptacles of the first and second coupling carriers are designed for inserting and fixing the plug-in coupling parts. The first coupling carrier and the second coupling carrier are designed such that the plug-in coupling parts of corresponding receptacles, which can be arranged in the receptacles, can be coupled by joining the first coupling carrier and the second coupling carrier together. The plug-in coupling parts of opposing receptacles that can be arranged in the receptacles are thus fluidically connected to each other when the two coupling carriers are joined together.

### 2. Description of Related Technology

Multiple couplings for media lines with plate-like coupling carriers are known in the state of the art in a variety of designs for different applications. Multiple couplings are always used when a number of media lines need to be coupled together simultaneously in an assembly process. In order to avoid having to couple all media lines individually, the media lines are each connected to a first or second plate-like coupling carrier via plug-in coupling parts, so that all media lines are connected to each other by connecting the two coupling carriers. In addition to simplifying assembly, maintenance work is also simplified, for example.

To prevent two media lines that do not belong together from being connected when coupling the first coupling carrier to the second coupling carrier, it must be ensured that the insertable plug-in coupling parts with the media lines are arranged at the position in the coupling carrier intended for the respective plug-in coupling part.

The measures known from the state of the art already ensure good protection against the interchanging of plug-in coupling parts or the mounting of plug-in coupling parts in receptacles not intended for this purpose. However, these can only be produced with increased effort.

### SUMMARY

The present invention is therefore based on the object of providing a multiple coupling for media lines which prevents incorrect assembly of plug-in coupling parts and in which the manufacturing effort is reduced.

The aforementioned object is solved in a generic multiple coupling for media lines having first and second coupling carriers, each with a first and a second receptacle, in that the first receptacle and the second receptacle of at least the second coupling carrier each have at least one stop means, and in that the stop means of the first receptacle has a different extension along a longitudinal axis of the respective receptacle than the stop means of the second receptacle. The different extension of the stop means determines different insertion depths for different plug-in coupling parts. A plug-in coupling part is only fixed in a receptacle if the stop means allows sufficient penetration of a plug-in coupling part into a receptacle for fixing.

The term “media line” generally refers to line connections for any flow and/or pressure media, such as gases or liquids. Media lines are basically pipe or hose lines as well as their connecting and joining elements that are part of a system for guiding a medium. In particular, such media lines are made of plastic.

The plate-like coupling carriers preferably have an essentially plane base surface in which the receptacles are formed. Each receptacle has fixing means for holding an insertable plug-in coupling part. The first and second coupling carriers each have at least two receptacles. Preferably, it is also provided that each coupling carrier has more than two receptacles, for example at least or exactly four or at least or exactly six receptacles. In the case of six receptacles, for example, at least four or at least five receptacles have a stop means. Provision is also made that, in the case of more than three receptacles per coupling carrier, at least two receptacles have an essentially identically designed stop means. It is particularly preferred that the multiple coupling has a plug-in coupling part for each receptacle of a coupling carrier. However, it is also provided that, depending on the intended use, only some of the receptacles of a coupling carrier are fitted with plug-in coupling parts.

The first coupling carrier and the second coupling carrier can preferably be connected to one another in exactly one alignment, in particular can be latched and/or screwed together. For example, it is provided that the first coupling carrier and the second coupling carrier each have at least one alignment means that enables the first coupling carrier and the second coupling carrier to be joined together in only one alignment with respect to one another, as a result of which the media lines connected or connectable to the coupling carriers are correctly assigned to one another. It is also provided that the first coupling carrier and the second coupling carrier have at least one, preferably two recesses for screwing the two coupling carriers together.

The plug-in coupling parts are designed such that the two plug-in coupling parts of two corresponding receptacles, namely those receptacles of the first coupling carrier and the second coupling carrier which are opposite each other in the mounted state, are fluidically connected to each other when the first coupling carrier and the second coupling carrier are joined together. Each plug-in coupling part has at least one interface for connecting to another plug-in coupling part. In the case of two plug-in coupling parts intended for joining together, at least one interface of one of the two plug-in coupling parts has at least one sealant. On the side facing away from the coupling carrier in the mounted state, a plug-in coupling part preferably has an interface to a media line, for example a connecting pin or a socket, or another media line interface or a functional component, for example a valve.

In order to advantageously ensure that only a plug-in coupling part that is also intended for this receptacle can be fixed in a receptacle, at least the first receptacle and the second receptacle of the second coupling carrier each have a stop means with a different axial extension. The axial extension always refers to the central or longitudinal axis of the respective receptacle. For example, a socket has at least one counter-stop means for interacting with the stop means. The mating stop means has, for example, at least one collar or at least one projection for interacting with a stop means.

The stop means are designed with their different axial extensions in such a way that a plug-in coupling part designed for insertion into the first receptacle cannot be fixed in the second receptacle and a plug-in coupling part designed for insertion into the second receptacle cannot be fixed in the first receptacle. The stop means prevent a latching means not intended for a receptacle from penetrating deep enough into the receptacle to interact with the fixing means, for example latching arms with latching projections. Although the plug-in coupling parts provided for the first and second receptacles can be inserted into the first and second receptacles, fixing only takes place with those plug-in coupling parts that are provided for the respective receptacle. In particular, the plug-in coupling parts for the first receptacle and the second receptacle of the second coupling carrier have a matching diameter.

Preferably, a stop means is arranged in such a way that it surrounds the receptacle circumferentially, at least partially or completely. The stop means, which is designed, for example, as a projection extending from a surface of the respective coupling carrier, preferably extends in the outer environment of a receptacle. The inner area, in particular the inner circumference, of the receptacle is therefore identical for both, in particular all, receptacles.

The invention is particularly suitable for use on commercial vehicle components, in particular for pre-assembly of a commercial vehicle axle with at least one electric motor, a manual transmission and a differential. The use of a multiple coupling according to the invention makes it possible to fill and test the commercial vehicle axle before it is actually mounted on the vehicle frame.

Compared to the prior art, the invention has the advantage that plug-in coupling parts with the same diameter can be used for the first receptacle and the second receptacle of the second coupling carrier without the risk of mounting a plug-in coupling part in a receptacle not intended for this purpose.

The object mentioned at the beginning is further solved in a generic multiple coupling in that at least one receptacle, in particular of the second coupling carrier, has at least one surrounding stop means with at least one projection and at least one recess in order to define at least one required insertion depth for fixing and at least one insertion orientation for a plug-in coupling part.

In particular, the stop means is arranged outside the actual receptacle, surrounding the receptacle. The receptacle is, for example, a receptacle of the first coupling carrier and/or the second coupling carrier. For example, the projection is arranged completely surrounding the receptacle and has at least one recess in its course. Preferably, at least or exactly two or at least or exactly three recesses are provided. The recesses are evenly or unevenly distributed around the circumference of the receptacle. For example, in the case of three recesses, the angle between the recesses is twice 110° and once 140°, so that the recesses are arranged asymmetrically. In particular, the recess or recesses extend completely in the projection or extend at least partially in the projection and partially into the coupling carrier.

The corresponding plug-in coupling part has protrusions that correspond to the recesses in particular, so that tilting of the plug-in coupling part is prevented during insertion. The possible insertion depth for a matching plug-in coupling part is defined by the interaction of the protrusion and the recesses, which is determined by the depth of the at least one recess. In addition, the arrangement of the at least one recess or recesses defines at least one insertion orientation for a plug-in coupling part. This is particularly important if the plug-in coupling part has an elbow and/or a valve that requires a certain alignment in the mounting position.

If, for example, the projections of a plug-in coupling part are positioned differently or if the plug-in coupling part has a continuous collar, it cannot be inserted into a receptacle with such a stop means.

The object mentioned at the beginning is further solved in a generic multiple coupling for media lines in that at least the first receptacle of the first coupling carrier and the second receptacle of the first coupling carrier have different radial properties in order to avoid interchanging plug-in coupling parts at least in the first coupling carrier, and in that at least the first receptacle in the second coupling carrier and the second receptacle in the second coupling carrier each have at least one stop means for defining different insertion depths for the first receptacle and the second receptacle in order to avoid interchanging plug-in coupling parts at least in the second coupling carrier. If there are two receptacles in each coupling carrier, “interchanging” means that a plug-in coupling part intended for the first receptacle cannot be fixed in or inserted into the second receptacle and vice versa. If there are more than two receptacles, “interchanging” means that only a plug-in coupling part intended for insertion into the respective receptacle can be inserted into each of the receptacles.

Preferably, the diameters of the first and second receptacles of the first coupling carrier and the second coupling carrier as well as the stopping means are selected and matched to each other in such a way that interchanging of plug-in coupling parts between the first coupling carrier and the second coupling carrier is also prevented.

The invention is based on the idea that interchanging of plug-in coupling parts in the first coupling carrier is prevented by varying the radial properties, in particular the diameter of the receptacles. This means that only plug-in coupling parts with the correct diameter can be inserted into or fixed in the appropriate receptacle. In the second coupling carrier, plug-in coupling parts are prevented from being mixed up by varying the insertion depth for the same diameter, so that although insertion is possible, fixing is only possible if the respective stop means, in cooperation with the plug-in coupling part, enables sufficiently deep penetration. Consequently, the axial properties of the receptacles are varied in the second coupling carrier. This ensures that only those plug-in coupling parts can be engaged with a respective receptacle that are also intended for this receptacle. At least two receptacles of the second coupling carrier therefore have a different latching depth with the same diameter.

The section of a plug-in coupling part, which has the interface to another plug-in coupling part and which can be inserted into the respective receptacle of a coupling carrier, is preferably rotationally symmetrical. The mating stop means of a plug-in coupling part, which interacts in particular with a stop means, is arranged outside the receptacle in the mounted state. Any necessary rotational alignment of a plug-in coupling part-insertion alignment—is preferably determined by interaction between a stop means and a counter-stop means. It is also provided that the stop means and the counter-stop means are designed in such a way that a plurality of insertion orientations are permissible, in particular two or three insertion orientations.

In a generic multiple coupling for media lines, it is further provided as a characterizing feature that at least one stop means is arranged on at least one receptacle on the first coupling carrier and/or on the second coupling carrier, and that the stop means is designed to predetermine at least one rotational orientation of an insertable plug-in coupling part-insertion orientation- and to define an insertion depth for the plug-in coupling part. The stop means is preferably arranged outside the receptacle, in particular on a surface of the coupling carrier.

One embodiment of the multiple coupling, already briefly described above, provides that the stop means of the first receptacle has a different extension along the respective longitudinal axis of a receptacle than the stop means of the second receptacle, whereby different insertion depths are realized for different plug-in coupling parts with the same diameter. The stop means are arranged, for example, as projections of different heights, each surrounding a receptacle. At least one of the projections preferably has at least one recess in order to define a required insertion depth for fixing a plug-in coupling part and, in particular, the insertion orientation of a plug-in coupling part.

According to a further embodiment of the multiple coupling, it is provided that the second coupling carrier has between two and eight receptacles. Preferably, the between two and eight receptacles are evenly distributed over the surface of the second coupling carrier. Preferably, the second coupling carrier has exactly six receptacles. Preferably, at least four receptacles have the same first diameter, at least one receptacle has a second diameter and at least one receptacle has a third diameter. In the four receptacles with the same first diameter, the stop means are designed in such a way that an identically designed plug-in coupling part can be inserted and fixed in three receptacles, possibly with a different insertion orientation. Only a single plug-in coupling part can be inserted into the fourth receptacle with the first diameter, which cannot be fixed simultaneously in the other three receptacles. The two other receptacles have a second diameter and a third diameter. The second diameter differs from the third and first diameters. The first receptacle and the second receptacle preferably have the first diameter.

This ensures that in the second coupling carrier, only the plug-in coupling part is fixed in a receptacle or can be inserted into it if it is intended for the receptacle.

According to a further embodiment of the multiple coupling, it is provided that the first coupling carrier has between two and eight receptacles. The between two and eight receptacles are preferably evenly distributed over the surface of the first coupling carrier. In particular, the first coupling carrier has six receptacles. The number of receptacles is preferably identical for the first and second coupling carrier.

The first coupling carrier has at least two receptacles with the same fourth diameter, at least two receptacles with the same fifth diameter, at least one receptacle with a sixth diameter and at least one receptacle with a seventh diameter.

Varying the diameters of the receptacles of the first coupling carrier prevents the plug-in coupling parts from becoming mixed up in the first coupling carrier. Preferably, the first to seventh diameters and the insertion or latching depths realized by the stop means are designed and matched to the plug-in coupling parts in such a way that the plug-in coupling parts provided for the first and second coupling carrier cannot be inserted into receptacles provided for them in the respective other coupling carrier.

According to a further embodiment, it has been found to be advantageous if it is provided that a stop means not only determines the insertion depth of a plug-in coupling part, but the stop means, in particular on the first receptacle of the second coupling carrier, is also designed to determine at least one insertion orientation of a plug-in coupling part. Preferably, it is provided that the stop means on at least one further receptacle, in particular the second receptacle of the second coupling carrier, cannot be used to determine a latching position. It is particularly preferred that, in the case of a plurality of receptacles, in particular of the second coupling carrier, at least three receptacles have a stop means with which an insertion orientation can also be determined, and at least two receptacles have a stop means which cannot be used to determine an insertion orientation.

In order to hold the plug-in coupling parts fixed in the receptacles, according to a further embodiment of the multiple coupling, it is provided that at least the first receptacle of the second coupling carrier and the second receptacle of the second coupling carrier each have a plurality of latching arms, each with at least one latching projection. The fixing means has a plurality of latching arms. The latching arms are arranged such that they can deflect in the radial direction of the receptacles in order to latch with the latching projections with a latching recess on a plug-in coupling part. In particular, the latching arms are aligned essentially parallel to the longitudinal axis of a receptacle.

It is preferable for the latching projections of the latching arms of the first receptacle and the second receptacle to be at the same distance from a surface O of the second coupling carrier. The different insertion depth is then realized exclusively by the stop means, which are arranged outside the receptacle, in particular surrounding the receptacle. Alternatively, it is also provided that the latching arms of the first receptacle and the second receptacle are at a different distance from a surface O of the second coupling carrier.

It is provided that the latching arms of the first receptacle and the second receptacle have the same length. However, it is particularly preferred that the latching arms of the first receptacle and the second receptacle have a different length, although the latching projections are at the same distance from the surface O of the second coupling carrier. If there are six receptacles in the second coupling carrier, it is preferably provided that latching arms with a longer length are arranged in at least two receptacles with the same diameter and latching arms with a shorter length are arranged in two receptacles with the same diameter.

According to a further embodiment of the multiple coupling, it is provided that at least the first receptacle of the first coupling carrier and the second receptacle of the first coupling carrier each have a plurality of latching arms, each with at least one latching projection. The fixing means has a plurality of latching arms. The latching projections of the latching arms of the first receptacle and the second receptacle are at the same distance from a surface O of the first coupling carrier. The variation of the insertion depth-if present—is then realized via the presence of stop means. The latching arms of the first receptacle and the second receptacle have the same or different lengths.

Preferably, the latching arms of the receptacles opposite each other in the mounted state of the first coupling carrier and the second coupling carrier are designed in such a way that they interact in the mounted state in such a way that a release of inserted plug-in coupling parts is blocked. Preferably, the lengths of the latching arms are matched to each other in such a way that short latching arms in the first coupling carrier and long latching arms in the second coupling carrier or long latching arms in the first coupling carrier and short latching arms in the second coupling carrier are opposite each other. When the two coupling carriers are joined together, the long and short latching arms interact in such a way that none of the latching arms can move out of its latching position with an inserted plug-in coupling part. The plug-in coupling parts are thus reliably fixed in their latching position.

For example, the long and short latching arms are arranged on the receptacles of the first coupling carrier and the second coupling carrier in such a way that the first coupling carrier and the second coupling carrier can only be joined in one orientation.

According to a further embodiment of the multiple coupling, it has proven to be particularly advantageous if it is provided that the stop means on the first receptacle of the second coupling carrier is designed as a circumferential projection with at least one recess, in particular as described above. For example, at least or exactly two or at least or exactly three recesses are formed.

Preferably, the stop means on the second receptacle is designed as a circumferential, preferably completely closed, projection. A plug-in coupling part with three protrusions as mating stop means, which can interact with the three recesses in the protrusion surrounding the first receptacle, can therefore not be inserted into the second receptacle with the circumferential protrusion. Conversely, a plug-in coupling part that is intended for insertion into the second receptacle cannot be inserted into the first receptacle, in particular because the stop means of the first receptacle has a larger axial extension. The projections of the stop means of the first receptacle and the second receptacle preferably have a different height, for example a height between 1 mm and 5 mm, preferably a height between 2 mm and 4 mm. Preferably, the projection on the first receptacle has a height of approximately 3 mm and the second receptacle has a height of approximately 2 mm.

According to a further embodiment of the multiple coupling, it is provided that at least the first receptacle of the first coupling carrier and the second receptacle of the first coupling carrier have a different diameter. This ensures that only plug-in coupling parts with the correct diameter can be inserted into and/or fixed in a receptacle.

A further embodiment of the multiple coupling provides that at least one plug-in coupling part, in particular on the side applied by the coupling carrier in the mounted state, has at least one pipe elbow with fluid channel, at least one barbed connection fitting, at least one valve, in particular a non-return valve or outlet stop valve with backflow prevention, at least one radially protruding projection, at least fleece oil filter and/or at least one membrane. The membrane is preferably impermeable to water and open to vapor diffusion and is made of polytetrafluoroethylene (PTFE), for example. The projection serves as a counterstop means for interacting with a stop means, in particular the recess of a stop means.

In particular, at least one plug-in coupling part has at least two interfaces in the form of sockets. At least one plug-in coupling part is therefore designed as a double coupling. This has the advantage that a media line can be easily detached from a coupling carrier for assembly or maintenance purposes without detaching the plug-in coupling part from the coupling carrier and without separating the multiple coupling, in particular the first coupling carrier and the second coupling carrier.

Preferably, at least one plug-in coupling part is designed such that it can only be fixed in the first receptacle of the second coupling carrier, at least one plug-in coupling part is designed such that it can only be fixed in the second receptacle of the second coupling carrier, at least one plug-in coupling part is designed such that it can only be fixed in the first receptacle of the first coupling carrier, and at least one plug-in coupling part is designed such that it can only be fixed in the second receptacle of the first coupling carrier.

The invention also relates to a plate-shaped coupling carrier according to one of the embodiments described above.

### BRIEF DESCRIPTION OF THE DRAWINGS

Further advantageous embodiments of the invention are shown in the following description of the figures.

FIG. 1 shows an embodiment of a second plate-like coupling carrier from the top,

FIG. 2 shows the embodiment of a plate-like coupling carrier as shown in FIG. 1 from the underside,

FIG. 3 shows an embodiment of a first plate-like coupling carrier from the top,

FIG. 4 shows an embodiment of a plate-like coupling carrier as shown in FIG. 3 from the underside,

FIG. 5 shows an embodiment of a multiple coupling,

FIG. 6 shows a different view of the embodiment of a multiple coupling as shown in FIG. 5,

FIG. 7 shows the embodiment of FIGS. 5 and 6 in a first section,

FIG. 8 shows the embodiment of FIGS. 5 and 6 in a second section, and

FIG. 9 shows a sectional view of an embodiment of a multiple coupling.

In the various figures in the drawing, identical parts are always marked with the same reference symbols.

### DETAILED DESCRIPTION

With regard to the following description, it is claimed that the invention is not limited to the embodiment and thereby not limited to all or several features of described feature combinations, rather each individual partial feature of the/each embodiment is also of significance for the object of the invention independently of all other partial features described in connection therewith, and also in combination with any features of another embodiment.

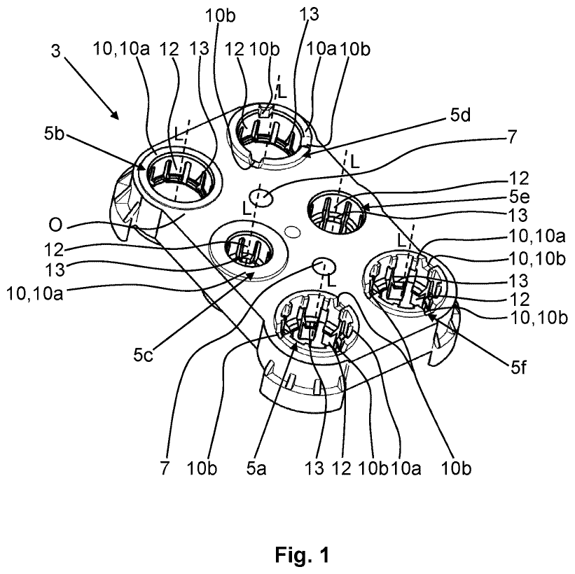

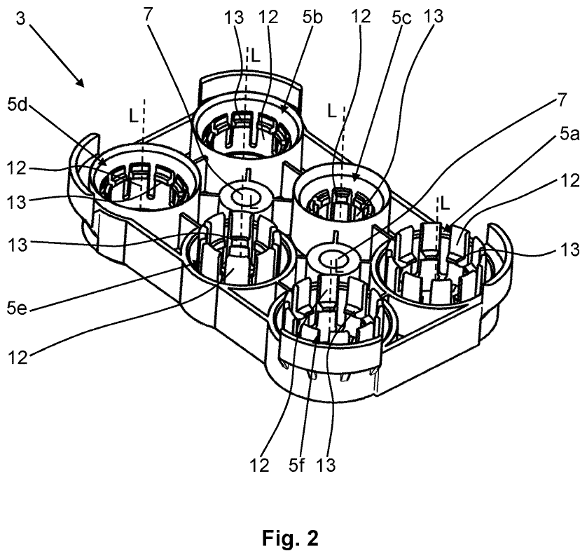

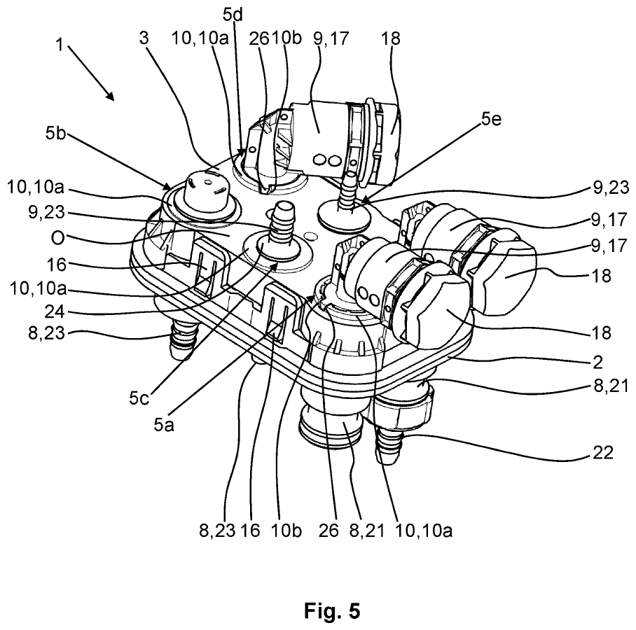

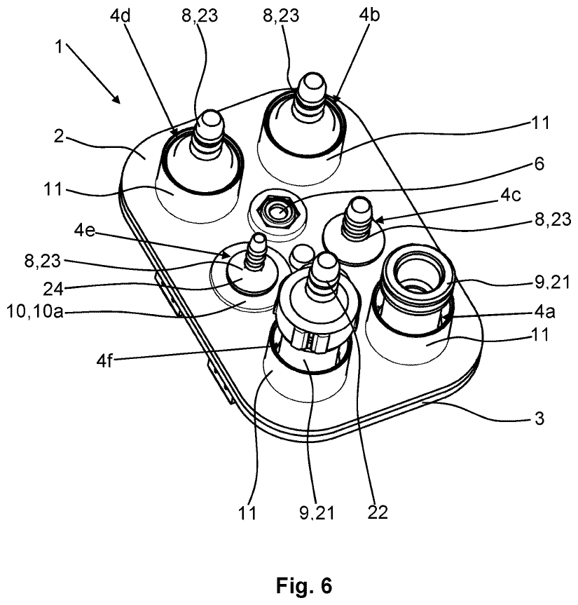

FIG. 1 and FIG. 2 show an embodiment of a second plate-like coupling carrier 3 for a multiple coupling 1 (see, for example, FIGS. 5 and 6) for media lines. FIG. 1 shows the top side, FIG. 2 shows the bottom side, which is joined to the first coupling carrier 2 during assembly—the joining side. The joining takes place in a direction parallel to the longitudinal axes L of the receptacles 5. The plate-like coupling carrier 3 has a first receptacle 5a, a second receptacle 5b, a third receptacle 5c, a fourth receptacle 5d, a fifth receptacle 5e and a sixth receptacle 5f. The receptacles 5 are arranged evenly in the base surface of the second coupling carrier 3.

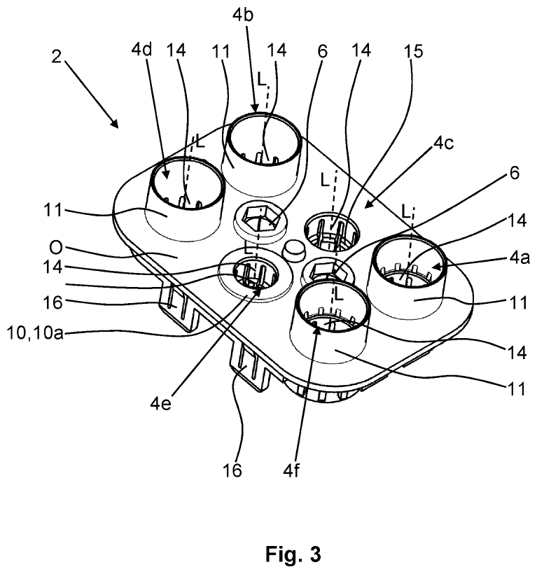

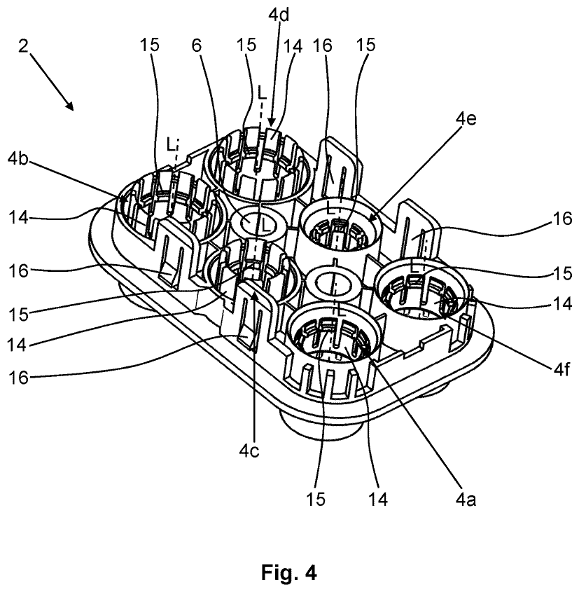

FIG. 3 and FIG. 4 show an embodiment of a first plate-like coupling carrier 2 for a multiple coupling 1 (see FIGS. 5 and 6). FIG. 3 shows the top side, FIG. 4 shows the bottom side, which is joined to the second coupling carrier 3 during assembly—the joining side. The joining takes place in a direction parallel to the longitudinal axes L of the receptacles 4. The first coupling carrier 2 has a first receptacle 4a, a second receptacle 4b, a third receptacle 4c, a fourth receptacle 4d, a fifth receptacle 4e and a sixth receptacle 4f.

According to FIGS. 3 and 4, the first coupling carrier 2 has two recesses 6 through which screws can pass in order to connect the first coupling carrier 2 to the second coupling carrier 3. For this purpose, the second coupling carrier 3 has recesses 7 as shown in FIGS. 1 and 2.

A plug-in coupling part 8, 9, shown by way of example in FIGS. 5, 6, 7 and 8, can be inserted into each of the receptacles 4, 5 according to FIGS. 1 to 4.

According to FIG. 1, the first receptacle 5a and the second receptacle 5b each have a stop means 10 which has a different extension along the respective longitudinal axis L of a receptacle 5 in order to realize different insertion depths for different plug-in coupling parts 8, 9, in particular with the same diameter. Starting from the surface O of the second coupling carrier 3, the stop means 10 of the first receptacle 5a has a greater extension along the longitudinal axis L than the stop means 10 of the second receptacle 5b. The stop means 10 of the first receptacle 5a is higher than the stop means 10 of the second receptacle 5b.

According to FIG. 1, the stop means 10 is designed as a projection 10a with at least one recess 10b. In the present case, three recesses 10b are provided, which extend at least partially into the surface O of the first coupling carrier 3. The stop means 10 of the second receptacle 5b is designed as a closed projection 10a. In this embodiment, the projections 10a of the stop means 10 of the first receptacle 5a, the fourth receptacle 5d and the sixth receptacle 5f have a height of 2 mm (starting from the surface O). The recesses 10b have a depth of 3 mm, i.e. they extend into the coupling carrier 3. The projection 10a of the stop means 10 of the second receptacle 5b has a height of 0.5 mm (starting from the surface O).

The different heights of the projections 10a in conjunction with the recesses 10b prevent a plug-in coupling part 9 intended for the first receptacle 5a from latching in the second receptacle 5b. Furthermore, a plug-in coupling part 9 provided for the second receptacle 5b cannot be latched in the first receptacle 5a. The fourth receptacle 5d and the sixth receptacle 5f also have a stop means 10, which is designed as in the first receptacle 5a. The only difference in the fourth receptacle 5d is that the recesses 10b have a slightly different orientation in order to define a different insertion orientation for a plug-in coupling part 9 (see FIG. 5). The same plug-in coupling parts 9 can therefore be inserted into the first receptacle 5a, the fourth receptacle 5d and the sixth receptacle 5f. The first receptacle 5a, the second receptacle 5b, the fourth receptacle 5d and the sixth receptacle 5f have a matching first diameter. The third receptacle 5c also has a stop means 10 in the form of a circumferential projection 10a. The fifth receptacle 5e has no stop means 10. The third receptacle 5c has a second diameter and the fifth receptacle 5e has a third diameter. The first, second and third diameters are different.

According to FIG. 3, the first receptacle 4a and the sixth receptacle 4f have the same fourth diameter. Furthermore, the second receptacle 4b and the fourth receptacle 4d have the same fifth diameter, which is different from the diameter of the first receptacle 4a and the sixth receptacle 4f. Furthermore, the third receptacle 4c has a sixth diameter and the fifth receptacle 4e has a seventh diameter. The fourth, fifth, sixth and seventh diameters are different from each other.

Preferably, it is provided that the third diameter and the sixth diameter are identical and/or that the second diameter and the seventh diameter are identical.

The fifth receptacle 4e also has a stop means 10 in the form of a projection 10a. In this embodiment, the first receptacle 4a, the second receptacle 4b, the fourth receptacle 4d and the sixth receptacle 4f also have a collar 11 in order to locally expand the installation space of the coupling carrier 2. The collar 11 fully surrounds the respective receptacle 4. The plug-in coupling parts 8 can be at least partially inserted into the collars 11.

According to FIG. 1 and FIG. 2, latching arms 12, each with a latching projection 13, are provided in each receptacle 5 of the second coupling carrier 3 in order to hold a plug-in coupling part 9 fixed within the respective receptacle 5. To insert a plug-in coupling part 9, the latching arms 12 can deflect in the radial direction of a receptacle 5. In the first receptacle 5a, the second receptacle 5b, the fourth receptacle 5d and the sixth receptacle 5f, the latching projections 13 are at the same distance along the respective longitudinal axis L from the surface O of the second coupling carrier 3. However, the latching arms 12 of the first receptacle 5a and the sixth receptacle 5f are longer than the latching arms 12 of the second receptacle 5b and the fourth receptacle 5d, in particular due to the presence of retaining pawls (see in particular FIG. 2).

According to FIGS. 3 and 4, each of the receptacles 4 has a plurality of latching arms 14 with latching projections 15. The latching arms 14 of the first receptacle 4a, the second receptacle 4b, the fourth receptacle 4d and the sixth receptacle 4f have an identical distance from the surface O of the first coupling carrier 2 along the longitudinal axis L. The latching arms 14 of the first receptacle 4a and the sixth receptacle 4f are shorter than the latching arms 14 of the second receptacle 4b and the fourth receptacle 4d.

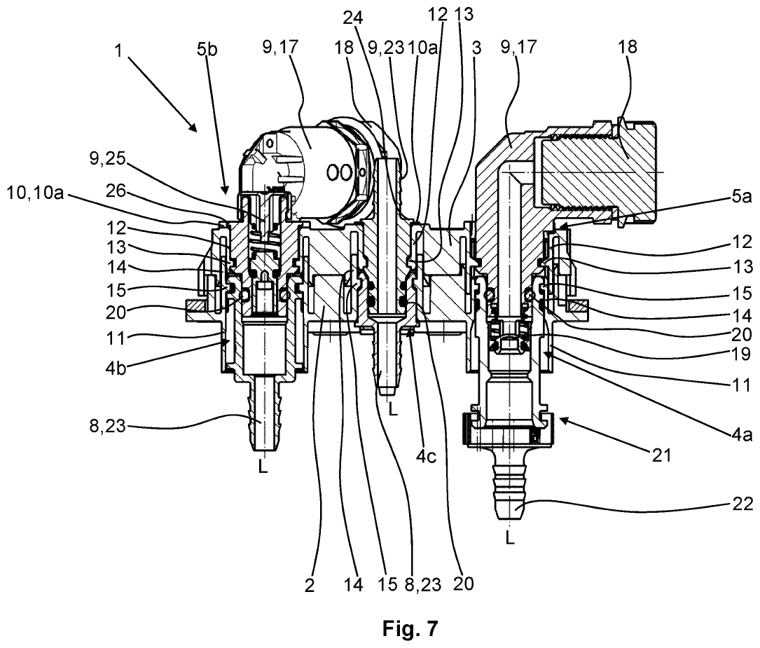

Overall, the latching arms 12, 14 of the first coupling carrier 2 and the second coupling carrier 3 are matched to each other in such a way that, when joined together, the corresponding receptacles 4, 5 each have short latching arms 12, 14 and long latching arms 12, 14 opposite each other, so that the short latching arms 12, 14 interact with the long latching arms 12, 14 in such a way that it is not possible to release the latching connection with the plug-in coupling parts 8, 9 (see FIGS. 6 and 7). In addition, the arrangement of the short and long latching arms 12, 14 ensures that the first coupling carrier 2 and the second coupling carrier 3 can only be joined together in a single orientation.

FIG. 5 and FIG. 6 show an example of a multiple coupling 1 in the joined state of the two coupling carriers 2, 3 with inserted plug-in coupling parts 8, 9. FIG. 5 shows the example of a multiple coupling 1 from the side of the second coupling carrier 3, FIG. 6 from the side of the first coupling carrier 2. For joining together, the first coupling carrier 2 has latching means 16 with which the second coupling carrier 3 can be fixed at least temporarily, in particular before screws are passed through the recesses 6, 7.

FIG. 7 shows a section through a multiple coupling 1 according to FIG. 5 and FIG. 6, which includes the longitudinal axes L of the first receptacle 5a and the second receptacle 5b of the second coupling carrier 3 as well as the first receptacle 4a and the second receptacle 4b of the first coupling carrier 2.

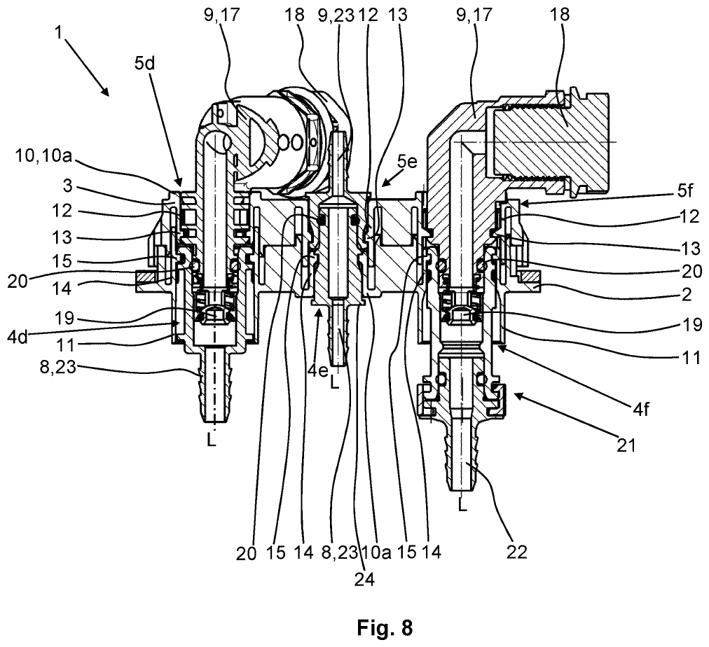

FIG. 8 shows a section through the multiple coupling 1 according to FIG. 5 and FIG. 6, which includes the longitudinal axes L of the sixth receptacle 5f and the fourth receptacle 5d of the second coupling carrier 3 and the sixth receptacle 4f and the fourth receptacle 4d of the first coupling carrier 2.

As can be seen from FIGS. 7 and 8, the latching arms 12, 14 act together in the joined state in such a way that the latching arms 12, 14 cannot move in a radial direction out of the latching state with the plug-in coupling parts 8, 9. As a result, the plug-in coupling parts 8, 9 are additionally secured in the assembled state of the multiple coupling 1.

According to FIGS. 5, 6 and 7, the plug-in coupling part 9 arranged in the first receptacle 5a has an elbow 17 with a fluid channel and an aeration and vent valve 18. The aeration and vent valve 18 has at least one membrane and a filter fleece and is used in particular to let air in and out. The plug-in coupling part 9 in the first receptacle 5a is positively-locking with the latching projections 13 of the latching arms 12. A plug-in coupling part 8, which is designed as a double coupling with a flow/outlet stop valve 19, is inserted into the receptacle 4a of the first coupling carrier 2, which corresponds to the first receptacle 5a. A sealant 20 is arranged between the joined plug-in coupling parts 8, 9 in order to create a fluid-tight connection. The latching arms 14 interact with the latching projections 15 with the plug-in coupling part 8 in a positive-locking manner.

The latching arms 12, 14 for the plug-in coupling parts 8, 9 are designed in such a way that they hold each other in the latching position in the mounted state shown. In this example, a coupling part 22 with a pin attachment is placed on a second coupling interface 21 of the plug-in coupling part 8, which is designed as a double coupling.

According to FIGS. 5, 6 and 7, a plug-in coupling part 9 with a connecting pin 23 is inserted into the third receptacle 5c. The plug-in coupling part 9 has a circumferential collar 24, which interacts with the stop means 10 in the form of a projection 10a. A plug-in coupling part 8 with a connecting pin 23 is also inserted into the third receptacle 4c of the first coupling carrier 2 and is fluidically connected to the plug-in coupling part 9 of the third receptacle 5c of the second coupling carrier 3.

A plug-in coupling part 9 with a vent valve 25 is inserted into the second receptacle 5b of the second coupling carrier 3 and latched with the latching arms 12. The vent valve 25 is used in particular to remove air. In the corresponding second receptacle 4b of the first coupling carrier 2, a plug-in coupling part 8 with a connecting pin 23 is inserted and fluidically connected to the plug-in coupling part 9 of the second receptacle 5b under the action of the sealants 20. The vent valve 25 has a significantly greater flow rate than the aeration and vent valves 18.

According to FIGS. 5, 7 and 8, the plug-in coupling parts 9 of the first receptacle 5a, the fourth receptacle 5d and the sixth receptacle 5f are designed identically and have a pipe elbow 17 with an aeration and vent valve 18. The aeration and vent valve is only shown schematically, particularly in the section in FIG. 7 and FIG. 8. Furthermore, the plug-in coupling parts 9 in these receptacles 5a, 5d, 5f each have three radially aligned projections 26 as counter-stop means, which engage in the recesses 10b in order to enable the latching arms 12 to latch with the plug-in coupling parts 9. The projections 26 also serve to determine the insertion orientation of the plug-in coupling parts 9, which is the same for the first receptacle 5a and the sixth receptacle 5f and is different for the fourth receptacle 5d with regard to the angle. The plug-in coupling parts 9 in these three receptacles 5a, 5d, 5f are identical. The second receptacle 5b has the same diameter as the first, fourth and sixth receptacles 5a, 5d, 5f, so that the plug-in coupling parts 9 of the first receptacle 5a, the sixth receptacle 5f and the fourth receptacle 5d could theoretically also be inserted into the second receptacle 5b. However, the stop means 10 in the form of the circumferentially closed projection 10a on the second receptacle 5b in cooperation with the projections 26 of the plug-in coupling parts 9 prevents the latching arms 14 from latching with the plug-in coupling parts 9, as no sufficient insertion depth is achieved.

According to FIGS. 5, 6 and 8, a plug-in coupling part 8 with a flow/outlet stop valve 19 is fitted in the sixth receptacle 4f of the first coupling carrier 2, which corresponds to the sixth receptacle 5f. The plug-in coupling part 8 is designed as a double coupling. A coupling part 22 with a connecting pin 23 is inserted at a second coupling interface 21. A plug-in coupling part 9 with a connecting pin 23 is inserted in the fifth receptacle 5e of the second coupling carrier 3. In the fifth receptacle 4e of the first coupling carrier 2, which corresponds to the fifth receptacle 5e, there is also a plug-in coupling part 8 with a connecting pin 23, which is joined to the other plug-in coupling part 9 by means of fluid technology under the effect of a sealant 20. In the fifth receptacle 4e of the first coupling carrier 2, a stop means 10 is again provided in the form of a circumferential projection 10a, which interacts with a collar 24 and prevents the plug-in coupling parts 8, 9 from being interchanged.

A plug-in coupling part 9, as already described, with an elbow 17 and an aeration and vent valve 18 is inserted into the fourth receptacle 5d of the second coupling carrier 3. A plug-in coupling part 8 with a flow/outlet stop valve 19 and a barbed connection fitting 23 is inserted into the fourth receptacle 4d of the first coupling carrier 2 corresponding to the fourth receptacle 5d, which is fluidically connected to the plug-in coupling part 9 of the fourth receptacle 5d of the second coupling carrier 3 under the effect of the sealant 20. The outlet stop valve 19 is optional at this location. It is also provided that the outlet stop valve 19 is not present at this location.

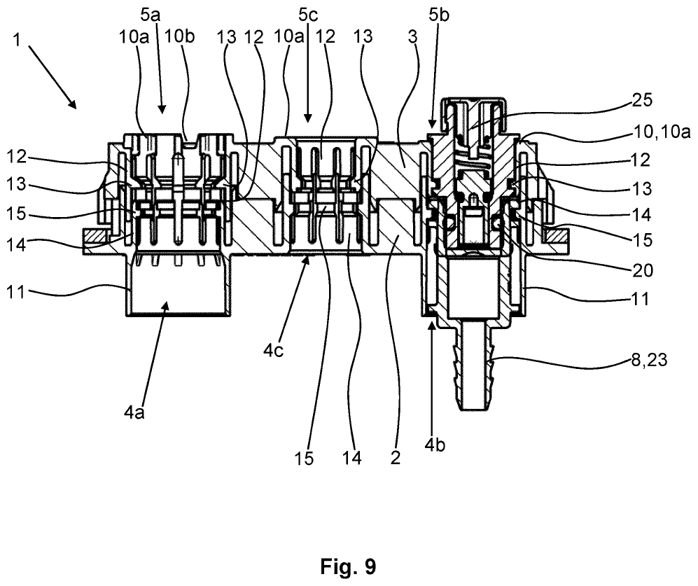

FIG. 9 shows an example of a multiple coupling 1 in which the first receptacle 5a of the second coupling carrier 3 and the corresponding first receptacle 4a of the first coupling carrier 2 as well as the third receptacle 5c of the second coupling carrier 3 and the third receptacle 4c of the first coupling carrier 2 are unused, i.e. no plug-in coupling parts 8, 9 are inserted. The assignment of the second receptacle 5b of the second coupling carrier 3 and the second receptacle 4b of the first coupling carrier 2 corresponds to that already described for FIG. 7.

In the unused receptacles 5a, 5c, 4a, 4c it can be seen how the latching arms 12, 14 with the different lengths lie one behind the other in the radial direction in the assembled state of the first coupling carrier 2 with the second coupling carrier 3 in order to prevent springing out and thus loosening of plug-in coupling parts 8, 9. The recess 10b in the projection 10a of the stop means 10 extends slightly into the second coupling carrier 3, namely slightly deeper, in this case approximately 1 mm, than the surface O of the second coupling carrier 3. The projection 10a of the stop means 10 protrudes from the surface O. Similarly, the stop means 10 of the third receptacle 5c, which is designed as a circumferential projection 10a, protrudes from the surface O.

In this embodiment, as in the embodiment example of FIGS. 5 and 6, the interchanging of plug-in coupling parts 9 in the second coupling carrier 3 is prevented predominantly by varying the insertion depth, namely by using stop means 10 with different axial extensions, which prevent the interchanging of plug-in coupling parts 9. On the side of the first coupling carrier 2, different radii are predominantly used for the receptacles 4 in order to prevent the plug-in coupling parts 8 from being interchanged. The radii and the stop means 10 are selected or designed in such a way that it is also not possible to interchange the plug-in coupling part 8 of the first coupling carrier with the plug-in coupling part 9 of the second coupling carrier 3.

The invention is not limited to the illustrated and described embodiments, but also includes all embodiments having the same effect in the sense of the invention. It is expressly emphasized that the embodiments are not limited to all features in combination; rather, each individual subfeature can also have an inventive significance in its own right independently of all other subfeatures. Furthermore, the invention is not yet limited to a specific combination of features, but can also be defined by any other combination of certain features of all the individual features disclosed. This means that, in principle, practically any individual feature can be omitted or replaced by at least one individual feature disclosed elsewhere in the application.

1. A multiple coupling for media lines, having at least one first plate-shaped coupling carrier, at least one second plate-shaped coupling carrier and a plurality of plug-in coupling parts, the first coupling carrier having at least one first receptacle and one second receptacle and the second coupling carrier having at least one first receptacle and one second receptacle wherein the receptacles are designed for inserting and for fixedly holding the plug-in coupling parts, wherein the first coupling carrier and the second coupling carrier are designed such that the plug-in coupling parts of corresponding receptacles which can be arranged in the receptacles can be coupled by joining together the first coupling carrier and the second coupling carrier,
wherein the first receptacle and the second receptacle of at least the second coupling carrier each have at least one stop, and in that the stop of the first receptacle has a different extension along a longitudinal axis than the stop of the second receptacle in order to realize different insertion depths for different plug-in coupling parts or at least one receptacle has at least one surrounding stop with at least one projection and at least one recess in order to define at least one insertion depth and at least one insertion orientation for a plug-in coupling part or at least one receptacle has at least one surrounding stop with at least one projection and at least one recess in order to define at least one insertion depth and at least one insertion orientation for a plug-in coupling part.

2. (canceled)

3. (canceled)

4. The multiple coupling according to claim 1, wherein the stop of the first receptacle has a different extension along a respective longitudinal axis of a receptacle than the stop of the second receptacle in order to realize different insertion depths for different plug-in coupling parts with the same diameter.

5. The multiple coupling according to claim 1, wherein the second coupling carrier has between two and eight receptacles, wherein at least four receptacles have the same first diameter, at least one receptacle has a second diameter and at least one receptacle has a third diameter.

6. The multiple coupling according to claim 1, wherein the first coupling carrier has between two and eight receptacles, wherein at least two receptacles have the same fourth diameter, at least two receptacles have the same fifth diameter, at least one receptacle has a sixth diameter and at least one receptacle has a seventh diameter.

7. The multiple coupling according to claim 1, wherein the stop on the first receptacle of the second coupling carrier, is designed to fix at least one insertion orientation of a plug-in coupling part.

8. The multiple coupling according to claim 1, wherein the first receptacle of the second coupling carrier and the second receptacle of the second coupling carrier each have a plurality of latching arms each with at least one latching projection.

9. The multiple coupling according to claim 1, wherein the first receptacle of the first coupling carrier and the second receptacle of the first coupling carrier each have a plurality of latching arms each with at least one latching projection.

10. The multiple coupling according to claims 8 and 9, wherein the latching arms of the receptacles opposite each other in the mounted state of the first coupling carrier and the second coupling carrier interact in such a way that a release of fixedly held plug-in coupling parts is blocked.

11. The multiple coupling according to claim 1, wherein at least one stop on the first receptacle of the second coupling carrier, is designed as a circumferential projection with at least one recess, and wherein the stop is designed as a circumferential projection on at least one further receptacle of the second coupling carrier.

12. The multiple coupling according to claim 1, wherein at least the first receptacle of the first coupling support and the second receptacle of the first coupling support have a different diameter.

13. The multiple coupling according to claim 1, wherein at least one plug-in coupling part has at least one of at least one valve, at least one barbed connecting fitting, at least one radially projecting protrusion, at least one fleece oil filter, at least one membrane or at least one pipe elbow with fluid channel.

14. A plate-shaped coupling carrier for a multiple coupling, for media lines, wherein the coupling carrier comprises at least a first receptacle and a second receptacle, wherein the receptacles are designed for the insertion and fixed mounting of plug-in coupling parts, wherein the first receptacle and the second receptacle of the coupling carrier each have at least one stop, and in that the stop of the first receptacle has a different extension along a longitudinal axis than the stop of the second receptacle in order to realize different insertion depths for different plug-in coupling parts.

15. A plate-shaped coupling carrier for a multiple coupling, the coupling carrier comprising at least a first receptacle and a second receptacle, wherein the at least first and second receptacles are designed for the insertion and fixed mounting of plug-in coupling parts, wherein at least one of the at least first and second receptacles has at least one surrounding stop with at least one projection and at least one recess in order to define at least one insertion depth and at least one insertion orientation for a plug-in coupling part.

16. The multiple coupling according to claim 5, wherein at least four receptacles have the same first diameter, at least one receptacle has a second diameter and at least one receptacle has a third diameter.

17. The multiple coupling according to claim 7, wherein the stop of at least one further receptacle cannot be used to fix an insertion orientation.

18. The multiple coupling according to claim 8, wherein the latching projections of the latching arms of the first receptacle and of the second receptacle are at the same distance from a surface of the second coupling carrier.

19. The multiple coupling according to claim 18, wherein the latching arms of the first receptacle and of the second receptacle have different lengths or the same length.

20. The multiple coupling according to claim 9, wherein the latching projections of the latching arms of the first receptacle and of the second receptacle are at the same distance from a surface of the first coupling carrier.

21. The multiple coupling according to claim 20, wherein the latching arms of the first receptacle and of the second receptacle have different lengths or the same length.
